(19) United States
(12) Patent Application Publication
(10) Pub. No.: US 2024/0011618 A1
(43) Pub. Date: Jan. 11, 2024

(54) VEHICLE SIDE LIGHT

(71) Applicant: KOITO ELECTRIC INDUSTRIES, LTD., Shizuoka (JP)

(72) Inventors: Shuhei KOJIMA, Sizuoka (JP); Kohei NOGAMI, Shizuoka (JP); Youmei KAMINAGA, Shizuoka (JP); Akira SAITO, Shizuoka (JP); Yasuyo KOJIMA, Shizuoka (JP)

(21) Appl. No.: 18/042,255

(22) PCT Filed: Jul. 5, 2021
(86) PCT No.: PCT/JP2021/025244

§ 371 Date: Feb. 20, 2023

(30) Foreign Application Priority Data
Aug. 31, 2020 (JP) 2020-146165

(51) Int. Cl. F21S 43/27; F21S 43/20; F21V 5/04

(52) U.S. Cl. CPC F21S 43/27; F21S 43/26; F21V 5/045; F21W 2103/15

(57) ABSTRACT

A vehicle side light that can decrease the number of components to reduce the cost, that does not produce a dark portion not easily visible, and that can more easily perform efficient light distribution control only in necessary directions with a simple configuration. In a vehicle side light (10) that is provided on a vehicle side surface, and that is constructed by supporting, in a light body (11), a light source (20) and a lens (30) for distributing light from the light source (20), the light source (20) is constructed by mounting a plurality of LEDs (22) on a surface of a single substrate (21), and the lens (30) is arranged in a front direction of the light source (20), and is capable of distributing light of any of the plurality of LEDs (22) to both sides of the vehicle side surface in addition to the front direction perpendicular to the vehicle side surface.

### TECHNICAL FIELD

The present invention relates to a vehicle side light that is provided on a vehicle side surface, and that is constructed by supporting, in a light body, a light source and a lens for distributing light from the light source.

### BACKGROUND ART

Conventionally, a vehicle side light is provided near the top of a door on a side surface of a railroad vehicle, and the vehicle side light illuminates to give a caution about the opening and closing of the door when the railroad vehicle is stopped (for example, Patent Literature 1). Generally, the vehicle side light is for a conductor on board and a station employee at a platform to confirm the illumination status from the both sides of its light body, i.e., the front and back direction of the vehicle. Therefore, basically, the vehicle side light is configured to illuminate two directions, i.e., the both sides of the light body (the front direction and the rear direction of the vehicle), and also to distribute light to the front direction of the light body (a side direction of the vehicle).

Although an electric bulb was used in the past as the light source of a vehicle side light, an LED (light emitting diode) is used these days (for example, paragraph 0012 of Patent Literature 1). When replacing the light source with an LED, it is conceivable to utilize an existing light body for electric bulb as is, which is already attached to a side surface of a vehicle, and to replace only a substrate for LED in the light body. Here, there has been a problem in that, when an LED simply arranged on a single substrate is used as illustrated in FIG. 3 of Patent Literature 1, the illumination direction of the LED is concentrated only in the front direction and the required luminous intensity for the both sides, illumination for which is essential, cannot be obtained due to narrow directional characteristics of the LED.

Therefore, for example, two substrates for LED are prepared, and each of the substrates is arranged to be inclined to a corresponding one of two directions on both sides. However, there has been a problem in that the two substrates are required, and a sheet metal for supporting each of the substrates is also separately required, and thus there are a large number of components. Additionally, the wiring to each of the substrates having the different directions also becomes complicated, resulting in cumbersome assembly and cost increase. Further, there has been a problem in that, in order to obtain the light distribution of the vehicle side light in the front direction as well as on the both sides, it is required to perform a special operation of bending a part of LEDs at right angles from a substrate so as to face the front direction, for example, which is more cumbersome, and moreover, a portion is generated that is dark and not easily visible, depending on a viewing direction.

In order to solve such problems, light distribution control using a lens is conceivable as means for easily performing special light distribution control in a case where an LED is used for a vehicle side light. For example, a lens is also known that can diffuse light in a straight direction from an LED on a substrate to lateral directions, although the lens is not related to a vehicle side light (for example, Patent Literature 2). This lens diffuses the light incident from one LED to the lateral directions so as to direct the light in a substantially horizontal circumferential direction as well as to the both sides that are perpendicular to an optical axis of the light.

### CITATION LIST

### Patent Literature

Patent Literature 1: Japanese Patent Laid-Open No. 2006-232037
Patent Literature 2: Japanese Patent Laid-Open No. 2013-61399

### SUMMARY OF INVENTION

However, when the aforementioned lens described in Patent Literature 2 is used for the light distribution control of a vehicle side light, there has been a problem in that the light distribution control in many directions unnecessary for the vehicle side light is also included, and the illumination efficiency is poor. Particularly, it has been difficult to actually realize the light distribution control mainly for the both sides with respect to a light source.

The present invention has been made by focusing on the problems in the related art as described above, and an object of the present invention is to provide a vehicle side light that can decrease the number of components to reduce the cost, that does not produce a dark portion not easily visible, and that can more easily perform efficient light distribution control only in necessary directions with a simple configuration.

In order to achieve the above-described object, an aspect of the present invention is

a vehicle side light that is provided on a vehicle side surface, and that is constructed by supporting, in a light body, a light source and a lens for distributing light from the light source,

wherein the light source is constructed by mounting a plurality of light emitting elements on a surface of a single substrate, and

the lens is arranged in a front direction of the light source, and is capable of distributing light of one of the plurality of light emitting elements to both sides of a vehicle side surface in addition to the front direction perpendicular to the vehicle side surface.

With the vehicle side light according to the present invention, the number of components can be decreased to reduce the cost, a dark portion not easily visible is not produced, and efficient light distribution control only in necessary directions can be more easily performed with a simple configuration.

### BRIEF DESCRIPTION OF THE DRAWINGS

FIG. 1 is a perspective view illustrating a state of inserting an attaching member in a light body of a vehicle side light according to a first embodiment of the present invention.

FIG. 2 is a perspective view illustrating the vehicle side light according to the first embodiment of the present invention, facing upward.

FIG. 3 is a vertical cross-sectional view illustrating the vehicle side light according to the first embodiment of the present invention.

FIG. 4 is a front view illustrating the vehicle side light according to the first embodiment of the present invention.

FIG. 5 is a rear view illustrating the vehicle side light according to the first embodiment of the present invention.

FIG. 6 is a right side view illustrating the vehicle side light according to the first embodiment of the present invention.

FIG. 7 is a left side view illustrating the vehicle side light according to the first embodiment of the present invention.

FIG. 8 is a plan view illustrating the vehicle side light according to the first embodiment of the present invention.

FIG. 9 is a bottom view illustrating the vehicle side light according to the first embodiment of the present invention.

FIG. 10 is a perspective view illustrating a state where a light source and a lens are attached to the attaching member of the vehicle side light according to the first embodiment of the present invention, facing upward.

FIG. 11 is a front view illustrating the state where the light source and the lens are attached to the attaching member of the vehicle side light according to the first embodiment of the present invention.

FIG. 12 is a rear view illustrating the state where the light source and the lens are attached to the attaching member of the vehicle side light according to the first embodiment of the present invention.

FIG. 13 is a right side view illustrating the state where the light source and the lens are attached to the attaching member of the vehicle side light according to the first embodiment of the present invention.

FIG. 14 is a left side view illustrating the state where the light source and the lens are attached to the attaching member of the vehicle side light according to the first embodiment of the present invention.

FIG. 15 is a plan view illustrating the state where the light source and the lens are attached to the attaching member of the vehicle side light according to the first embodiment of the present invention.

FIG. 16 is a bottom view illustrating the state where the light source and the lens are attached to the attaching member of the vehicle side light according to the first embodiment of the present invention.

FIG. 17 is a development view illustrating the attaching member of the vehicle side light according to the first embodiment of the present invention.

FIG. 18 is a perspective view illustrating the lens of the vehicle side light according to the first embodiment of the present invention.

FIG. 19 is a front view illustrating the lens of the vehicle side light according to the first embodiment of the present invention.

FIG. 20 is a cross-sectional view taken along line XX-XX in FIG. 19.

FIG. 21 is a cross-sectional view taken along line XXI-XXI in FIG. 19.

FIG. 22 is an explanatory diagram illustrating the light distribution of the lens of the vehicle side light according to the first embodiment of the present invention.

FIG. 23 is an explanatory diagram illustrating the light distribution of an additional light distribution controlling unit of the lens of the vehicle side light according to the first embodiment of the present invention.

FIG. 24 is a perspective view illustrating a vehicle side light according to a second embodiment of the present invention.

FIG. 25 is a vertical cross-sectional view illustrating the vehicle side light according to the second embodiment of the present invention.

FIG. 26 is a front view illustrating the vehicle side light according to the second embodiment of the present invention.

FIG. 27 is a rear view illustrating the vehicle side light according to the second embodiment of the present invention.

FIG. 28 is a right side view illustrating the vehicle side light according to the second embodiment of the present invention.

FIG. 29 is a left side view illustrating the vehicle side light according to the second embodiment of the present invention.

FIG. 30 is a plan view illustrating the vehicle side light according to the second embodiment of the present invention.

FIG. 31 is a bottom view illustrating the vehicle side light according to the second embodiment of the present invention.

FIG. 32 is a perspective view illustrating a state where a light source and a lens are attached to an attaching member of the vehicle side light according to the second embodiment of the present invention.

FIG. 33 is a front view illustrating the state where the light source and the lens are attached to the attaching member of the vehicle side light according to the second embodiment of the present invention.

FIG. 34 is a rear view illustrating the state where the light source and the lens are attached to the attaching member of the vehicle side light according to the second embodiment of the present invention.

FIG. 35 is a right side view illustrating the state where the light source and the lens are attached to the attaching member of the vehicle side light according to the second embodiment of the present invention.

FIG. 36 is a left side view illustrating the state where the light source and the lens are attached to the attaching member of the vehicle side light according to the second embodiment of the present invention.

FIG. 37 is a plan view illustrating the state where the light source and the lens are attached to the attaching member of the vehicle side light according to the second embodiment of the present invention.

FIG. 38 is a bottom view illustrating the state where the light source and the lens are attached to the attaching member of the vehicle side light according to the second embodiment of the present invention.

FIG. 39 is a development view illustrating the attaching member of the vehicle side light according to the second embodiment of the present invention.

FIG. 40 is a perspective view illustrating a lens according to Modification 1.

FIG. 41 is a perspective view illustrating a lens according to Modification 2.

### DETAILED DESCRIPTION OF THE EMBODIMENTS

Each embodiment representing the present invention will be described below based on the drawings.

Vehicle side lights 10 and 100 according to respective embodiments are lights provided on a vehicle side surface. Note that, although the kinds of the vehicle side lights 10 and 100 are not particularly limited, a description will be given below of an example in which the vehicle side lights 10 and 100 are applied to, for example, door closing vehicle side lights that are above a door on a side wall surface (vehicle side surface) of a railroad vehicle, and that illuminate red in a state where the door is not closed at the time of automatically opening and closing the door.

### First Embodiment

### <Outline of Vehicle Side Light 10>

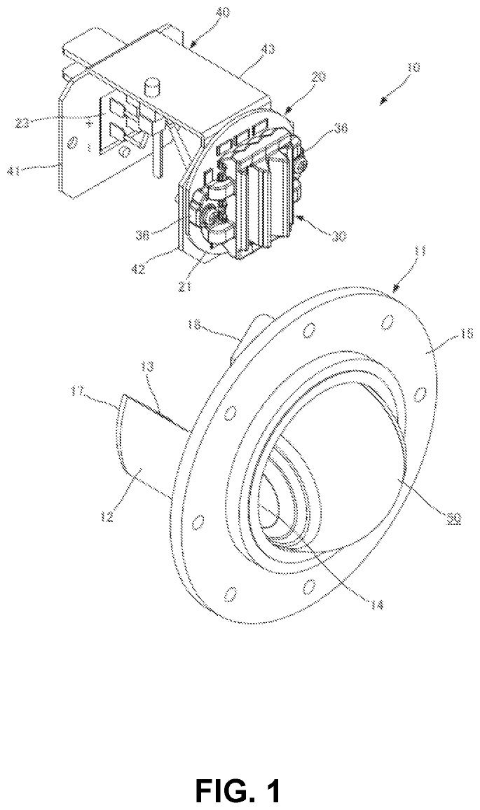

As illustrated in FIG. 1, a vehicle side light 10 includes a light body 11 to be fixed to a vehicle side surface, a light source 20 to be housed in the light body 11, a lens 30 that distributes light from the light source 20, and a support member to which the light source 20 and the lens 30 are attached in advance, and that is supported in the light body 11. An outer lens 50 for surrounding the lens 30 is provided in the light body 11. The light body 11 and the outer lens 50 form the outline of the entire vehicle side light 10, and are fixed to a side wall surface A of a railroad vehicle as illustrated in FIG. 3. The light source 20 and the lens 30 can be replaced together with the support member 40 from the light body 11 in this fixed state.

### <Regarding Light Body 11>

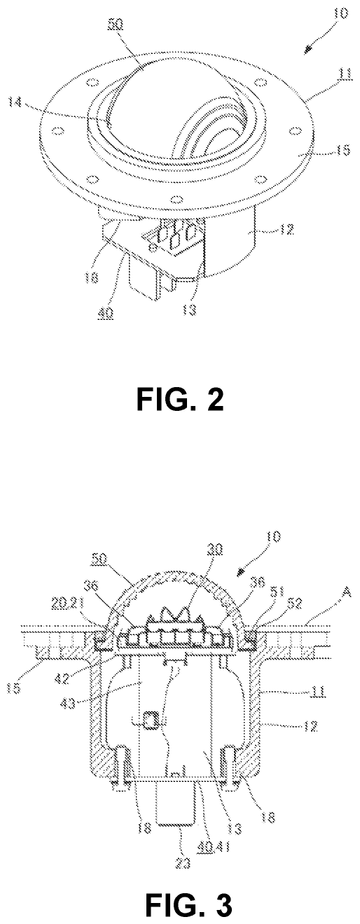

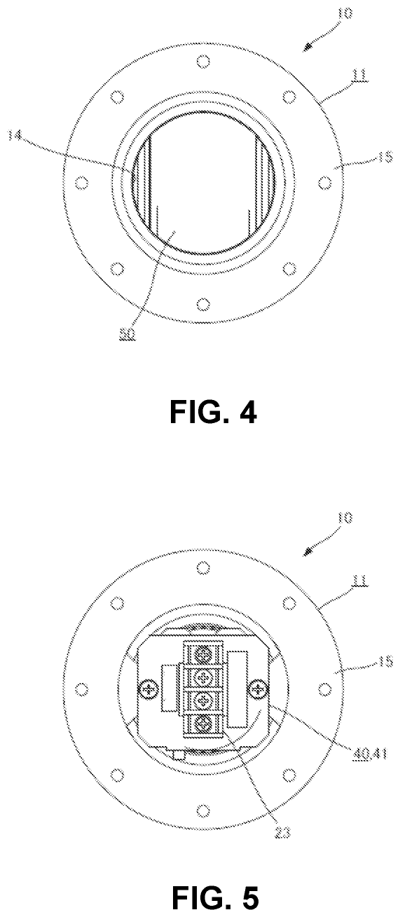

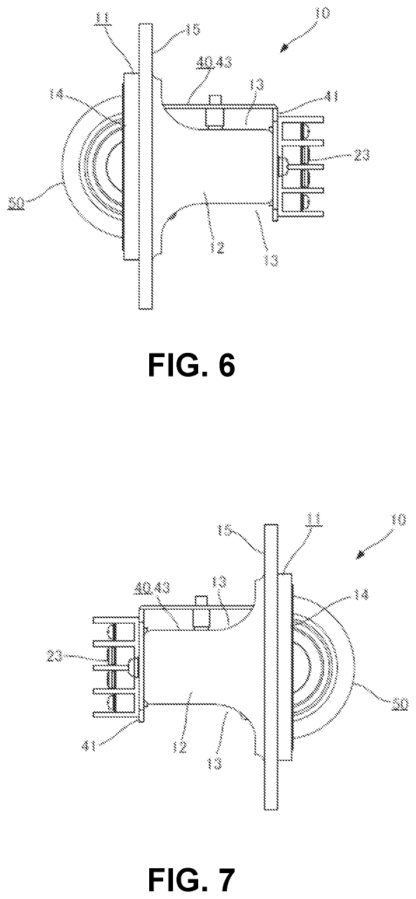

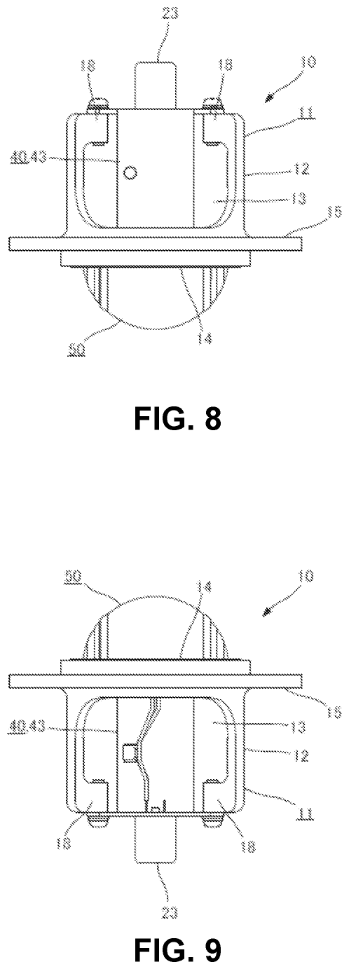

As illustrated in FIG. 1 to FIG. 9, the light body 11 is generally cylindrical, is provided with a flange 15 in the circumference of a front end opening 14, and is integrally formed from a metal such as an aluminum alloy by die casting or the like. A peripheral wall 12 of the light body 11 includes openings 13 defined by portions which face each other in a diameter direction perpendicular to a central axis of the light body 11 and are largely spaced from each other with cut out portions therebetween. The front end opening 14 of the light body 11 is opened in a complete circular shape, and the flange is provided on an outer circumference side of the front end opening 14 so as to extend outward with a predetermined width.

As illustrated in FIG. 3, a step 16 to be engaged with a peripheral edge of the outer lens 50 having a glove shape is provided inside the front end opening 14 of the light body 11. Additionally, although a rear end opening 17 of the light body 11 is directly continuous with the openings 13 on both sides and is opened widely, a pair of attaching pieces 18 are provided inside the rear end opening 17, and the pair of attaching pieces 18 inwardly project from a rear end edge of the peripheral wall 12 remaining between the openings 13 on the both sides, and face each other.

Each of the attaching pieces 18 is a portion to which the support member 40 is to be fixed. The opening area of the rear end opening 17 is reduced by the amount of each of the attaching pieces 18 projecting inward. Therefore, a member having a size corresponding to a cross-sectional area inside the light body 11 cannot be inserted to the inside along the central axis from the rear end opening 17 of the light body 11. Note that the outer lens 50 covering the front end opening 14 of the light body 11 will be described later.

### <Regarding Light Source 20>

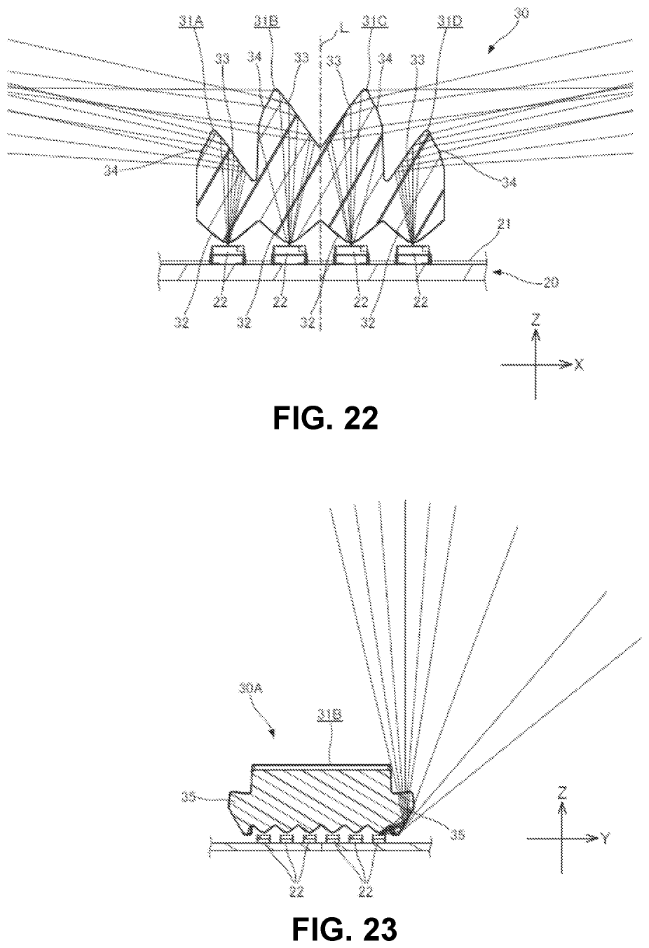

As illustrated in FIG. 1, the light source 20 is constructed by mounting the plurality of light emitting elements on the surface of the single substrate 21. Here, for example, LEDs 22 are suitable for the light emitting elements. As illustrated in FIG. 22, specifically, the LEDs 22 are, for example, surface mount type LED chips, and although a detailed description of their configurations will be omitted since the configurations are common, the LED chips emit light in a predetermined angular radiation range (light column characteristics) about the optical axis perpendicular to a chip surface.

Each LED 22 is mounted in a state where the optical axis of each LED is aligned parallel in the same direction perpendicular to the substrate 21. Although the light emission color of the LEDs 22 is a design matter that can be appropriately selected, in the present embodiment, red light is employed in accordance with the specifications on a door closing vehicle side light. Note that the LEDs 22 are not necessarily limited to the surface mount type LED chips, and may be LED lamps in which a chip is embedded into a cannonball type mold.

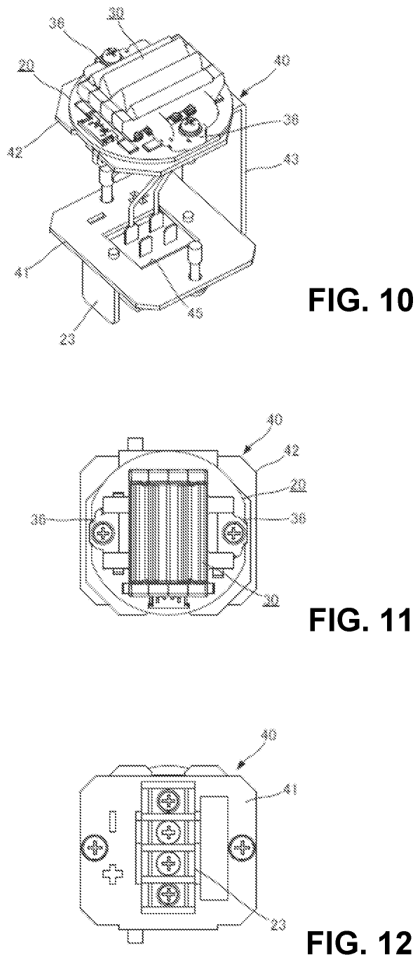

As illustrated in FIG. 1 and FIG. 10, the substrate 21 substantially agrees with, for example, the inside of the front end opening 14 of the light body 11, and is formed into a disc shape having a diameter that does not interfere with an inner peripheral wall of the light body 11. The substrate 21 is designed to secure the maximum light emission area in the limited space in the light body 11. A wiring circuit is provided on the surface of the substrate 21, and the plurality of LEDs 22 are mounted on the wiring circuit.

The LEDs 22 in the present embodiment are mounted such that the LEDs 22 are aligned in four columns in transverse directions as illustrated in FIG. 22 in a portion near the center on the surface of the substrate 21, and six LEDs 22 are arranged at equal intervals in each column as illustrated in FIG. 23, so that a total of 24 LEDs 22 are aligned in a matrix. The lens 30, which will be described later, is arranged in front of the LEDs 22 arranged in this manner, so as to overlap with the LEDs 22. Additionally, a resistance, a capacitor, and the like are also disposed on the surface of the substrate 21 as associated components. Note that the shape of the substrate 21 is not limited to a circle, and is a design matter that can be appropriately defined.

### <Regarding Support Member 40>

As illustrated in FIG. 1, the light source 20 and the lens which will be described later, are attached to the support member 40 in advance, and then the support member 40 is supported in the light body 11. The support member 40 generally has a shape that exactly fits into the light body 11, and is integrally formed from a sheet metal of, for example, an aluminum alloy. To be specific, the support member 40 includes a fixing surface part 41 to be fixed to each of the attaching pieces 18 inside the rear end opening 17 of the light body 11, an attaching surface part 42 to which the substrate 21 of the light source 20 is attached, and a leg 43 that connects the fixing surface part 41 and the attaching surface part 42 parallel to each other.

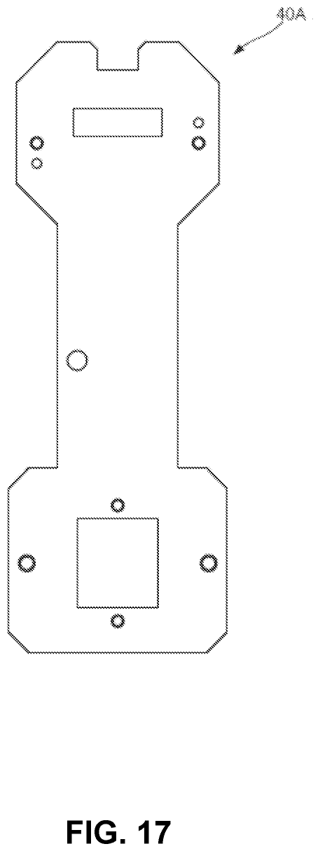

The fixing surface part 41 and the attaching surface part 42 face each other in a parallel manner with the leg 43 interposed therebetween. That is, the support member 40 is generally formed into a substantially U-shape in lateral view. Here, the leg 43 is formed into a rectangular shape extending with a width narrower than the maximum width of either of the fixing surface part 41 and the attaching surface part 42. By forming the support member 40 from a metal having an excellent thermal conductivity, the support member 40 will be a member serving as a heat sink. The support member 40 as described above is formed by bending one sheet metal 40A cut out into a predetermined shape as illustrated in FIG. 17.

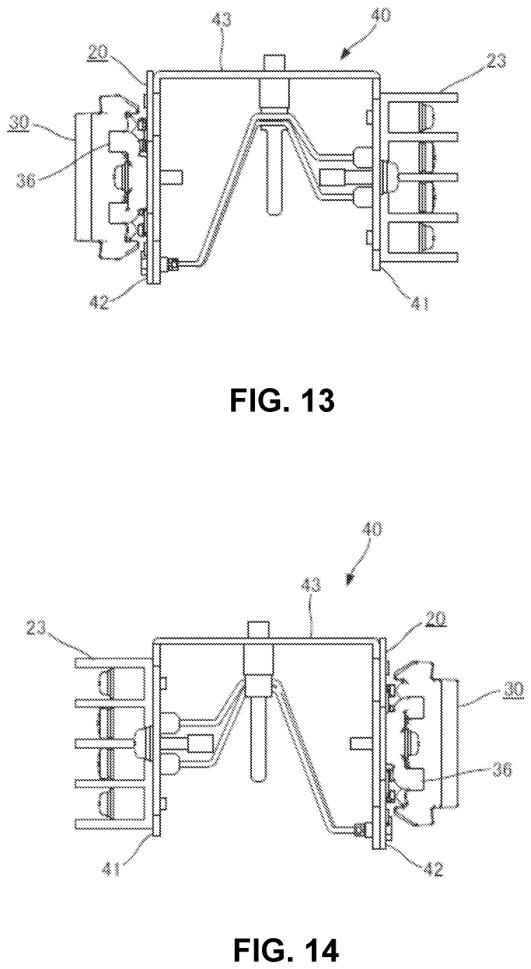

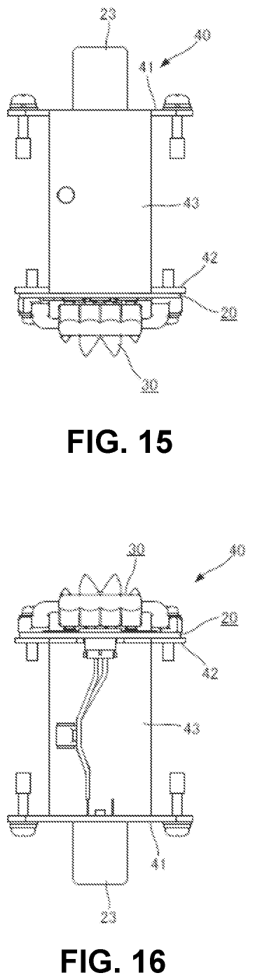

As illustrated in FIG. 10 to FIG. 16, the attaching surface part 42 is a portion to which a rear surface of the substrate 21 of the light source 20 is attached by surface contact, and is formed into a substantially octagon shape with which almost the entire area of the substrate 21 is overlapped. The attaching surface part 42 is provided with an insertion hole 44 (see FIG. 3) into which a power supply cable and an earth cable to be connected to the LEDs 22 and the associated components on the substrate 21 are inserted downward as well as holes for screws for fixing the substrate 21 and the lens 30.

The fixing surface part 41 is a portion to be fixed in a state of covering the rear end opening 17 of the light body 11, and is formed into a substantially rectangular shape covering almost the entire rear end opening 17. The fixing surface part 41 is provided with a mounting hole 45 for attaching a terminal block 23, which is an associated component of the light source as well as holes for screws for fixing to each of the attaching pieces 18 inside the rear end opening 17. By fixing the fixing surface part 41 to each of the attaching pieces 18, the support member 40 is supported in the light body 11 in a state where a central axis of the substrate 21, which is a central axis of the light source 20, is overlapped with the central axis of the light body 11.

As illustrated in FIG. 1, the support member 40 is configured to be insertable into the light body 11 together with the light source 20 and the lens 30, which will be described later, from a direction intersecting the central axis of the light body 11. Here, the attaching surface part 42 of the support member 40 has a size to fit the substrate 21 with which the maximum light emission area is secured in the limited space in the light body 11. Therefore, the support member 40 cannot be inserted from a direction along the central axis of the light body 11, since the attaching pieces 18 will be in the way when the support member 40 is inserted from the rear end opening 17 of the light body 11.

However, since there are the large openings 13 on the both sides of the peripheral wall 12 of the light body 11, it is designed such that the support member 40 can be inserted into the light body 11 from a direction passing through the openings 13, that is, a direction intersecting the central axis of the light body 11. Here, the leg 43 of the support member 40 is formed to have a narrow width, and does not interfere with the openings 13. Additionally, the widths of the attaching surface part 42 of the support member 40 and the substrate 21 of the light source 20 are also dimensioned to fit into the openings 13. Note that the fixing surface part 41 of the support member is not a portion that fits into the light body 11, since the fixing surface part 41 of the support member 40 is screwed to each of the attaching pieces 18 from the outside of the rear end opening 17 of the light body 11.

### <Regarding Lens 30>

As illustrated in FIG. 1, the lens 30 is an optical component that is arranged in a front direction of the light source 20, and is capable of distributing light of one of the plurality of LEDs 22 to the both sides of the vehicle side surface in addition to the front direction perpendicular to the vehicle side surface. The substrate 21 of the light source 20 is supported with respect to the light body 11 by the support member 40 in a state where the substrate 21 of the light source becomes parallel to the vehicle side surface. The lens 30 is attached in a state where the both ends of the lens 30 face the both sides of the vehicle side surface on the surface of the substrate 21.

Additionally, the lens 30 is attached on the surface of the substrate 21 in a state of covering the plurality of LEDs 22 of the light source 20 from the front direction. Here, the lens 30 may be designed to cover not only the LEDs 22, but also all the other electronic components, such as a resistance and a capacitor, disposed on the surface of the substrate 21 from the front direction. Note that attaching portions 36 to be fixed on the substrate 21 with screws or the like are provided on the both sides of the lens 30. The attaching portions 36 do not particularly perform light distribution control.

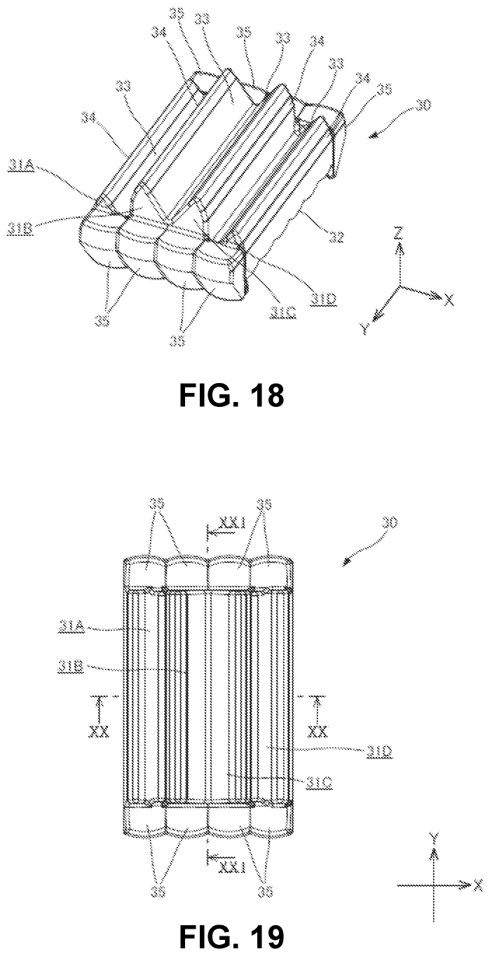

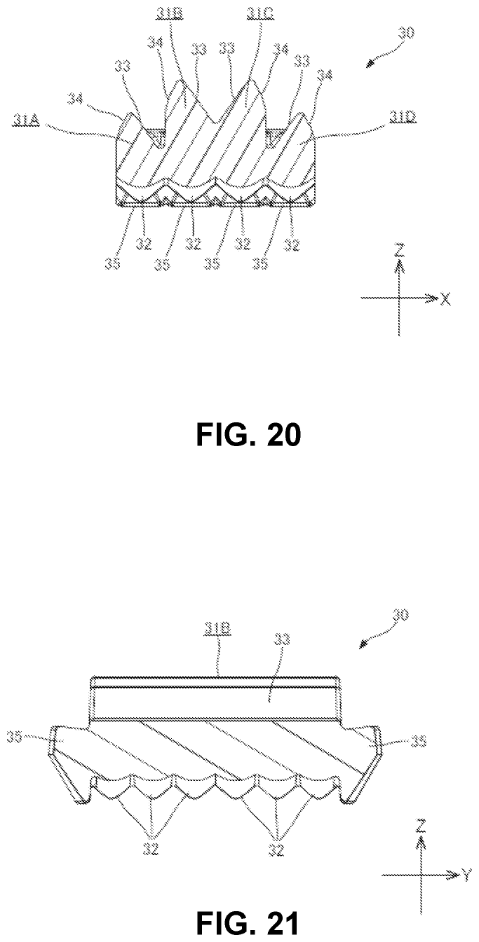

In FIG. 18 to FIG. 23, the directions of 3 axes of a Cartesian coordinate system in the lens 30 will be defined first. An X-axis matches with a direction (column direction) in which the columns of the LEDs 22 are aligned, and indicates transverse directions of the lens 30 (and the substrate 21) that matches with a direction perpendicular to the optical axes of the LEDs 22. A Y-axis is in a direction perpendicular to the X-axis, and indicates an up-and-down direction of the lens 30 (and the substrate 21) that matches with the direction (row direction) in which the six LEDs 22 are aligned in each column. A Z-axis is in a direction perpendicular to the X-axis and the Y-axis, and indicates the front and back direction of the lens (and the substrate 21) that matches with a direction parallel to the optical axes of the LEDs 22. Note that the attaching portions 36 of the lens 30 are omitted in FIG. 18 to FIG. 23.

As illustrated in FIG. 18, the lens 30 has a generally vertical rectangular shape that is long in the up-and-down direction in planar view, and is formed to have the same cross-sectional shape (see FIG. 22) along its whole length in the up-and-down direction, except for an additional light distribution controlling unit 35, which will be described later. For example, the lens 30 may be integrally molded from a transparent material, such as acrylic or polycarbonate, with a mold, or may be formed by being cut out from a lump of the transparent material. Specifically, for example, the inventions described in Japanese Patent Application No. 2019-120777, Japanese Patent Application No. 2019-120778, and the like, which have been already proposed by the present applicant, may be utilized for the lens 30 as described above.

### <<Light Distribution Controlling Unit 31>>

The lens 30 performs light distribution control of the light from each of the LEDs 22 on the substrate 21 in each column of the LEDs 22. That is, the lens 30 includes a plurality of (four) light distribution controlling units 31A, 31B, 31C, and 31D that are consecutively aligned in the transverse directions so as to correspond to the respective columns (four columns) of the LEDs 22, and that define the traveling direction of the light from the plurality of (six) LEDs 22 aligned in each column. Note that, when collectively referring to the light distribution controlling units 31A, 31B, 31C, and 31D, they are simply written as the light distribution controlling unit 31.

The same number of the light distribution controlling units 31 are symmetrically provided on the left side and the right side of a center line L (see FIG. 22) of the transverse directions of the lens 30. In the present embodiment, a total of four light distribution controlling units 31 are integrally and consecutively aligned in a state where the light distribution controlling units 31 are adjacent to each other, with two light distribution controlling units 31 being on each of the left side and the right side of the center line L of the lens 30. Each light distribution controlling unit 31 corresponds to each column of the LEDs 22 that are aligned in the four columns in the transverse directions on the substrate 21. Note that, although each of the light distribution controlling units 31 is horizontally and integrally molded as a partial region of the lens 30, separately provided light distribution controlling units 31 may be combined into one piece.

### <<Light Distribution by Light Distribution Controlling Unit 31>>

Among the light distribution controlling units 31, the two light distribution controlling units 31A and 31B aligned on the left side are formed to emit light incident from the LEDs 22 of the columns corresponding to the respective light distribution controlling units 31 to one direction (the left direction on the paper of FIG. 22) of the transverse directions intersecting the optical axis of the LEDs 22 in each column. Here, “one direction of the transverse directions intersecting the optical axis” is not limited to the direction perpendicular to the optical axis, and may be one direction of directions whose angle of intersection with the optical axis is in a range close to right angles, and that extend in the transverse directions of the optical axis.

On the other hand, among the light distribution controlling units 31, the two light distribution controlling units 31C and 31D aligned on the right side are formed to emit light incident from the LEDs 22 of the columns corresponding to the respective light distribution controlling units 31 to the other direction (the right direction on the paper of FIG. 22) that is opposite to the one direction of the transverse directions intersecting the optical axes of the LEDs 22 in each column. Here, “the other direction that is opposite to the one direction” is not necessarily limited to the opposite direction on the straight line extending in the one direction, and may be a direction extending linearly symmetrically to the straight line extending in the one direction about the center line L.

Among the light distribution controlling units 31, the leftmost light distribution controlling unit 31A and the rightmost light distribution controlling unit 31D are bilaterally symmetrical, and are formed into the same shape facing opposite directions. Similarly, the left-hand side light distribution controlling unit 31B and the right-hand side light distribution controlling unit 31C are bilaterally symmetrical, and are formed into the same shape facing opposite directions. Note that each light distribution controlling unit 31 has almost the same vertical cross-sectional shape (see FIG. 23) in the up-and-down direction from its upper end surface to lower end surface.

It is not necessarily required to symmetrically provide the same number of light distribution controlling units 31 on the left side and the right side. That is, as long as it is possible to allocate the respective illumination directions to one direction of the transverse directions intersecting the optical axes of the LEDs 22 and to the other opposite direction with a center line (which is not necessarily located on the center of the both ends) dividing one end side and the other end side in the transverse directions of the lens 30 therebetween, it is also possible to change the shapes and numbers of the light distribution controlling units 31 on the left side and the right side of the center line.

When it is assumed that the lens 30 is divided into two sides by the center line L (see FIG. 22) of the transverse directions, in the light distribution controlling units 31 on one half side, the optical paths guiding the light incident from the LEDs 22 of the columns corresponding to the respective light distribution controlling units 31 in an optical axis direction become sequentially shorter in the order from a center side to an outer side (the one end side or the other end side) of the transverse directions. Note that, although the number of the light distribution controlling units 31 on one half side of the lens 30 is only two in the present embodiment, three or more light distribution controlling units 31 may be aligned.

When referring to the length of the optical path of each light distribution controlling unit 31 as the height, for example, each of the two light distribution controlling units 31C and 31D on the right half side is configured to emit the light incident from the LEDs 22 of the corresponding column from a position (front and back position) at a height not interfering with the light distribution controlling unit 31 adjacent to the outer side (the other end side) to the same direction (the above-described other direction) of the transverse directions intersecting the optical axes of the LEDs 22. In the present embodiment, the light distribution controlling units 31C and 31D have respective portions for emitting light to the same direction (the above-described other direction) (emitting portions 34, which will be described later) of respective tip sides, which are made sequentially lower in a staircase manner.

The same applies bilaterally symmetrically to the light distribution controlling units 31A and 31B on the left half side of the lens 30, and each of the two light distribution controlling units 31A and 31B is configured to emit the light incident from the LEDs 22 of the corresponding column from a position (front and back position) at a height not interfering with the light distribution controlling unit 31 adjacent to the outer side (the one end side) to the same direction (the above-described one direction) of the transverse directions intersecting the optical axes of the LEDs 22. Note that the left side and right side of the lens 30 may be divided and molded as separate parts in advance, and may thereafter be combined into one piece.

### <<Details of Configuration of Light Distribution Controlling Unit 31>>

As illustrated in FIG. 22, although there is a difference in the size and the orientation, each light distribution controlling unit 31 has a common basic configuration. That is, each light distribution controlling unit 31 includes an incidence portion 32, a reflection portion 33, and the emitting portion 34. The incidence portion 32 is a portion that is arranged to face each column of the LEDs 22, and on which the light centered on the optical axes from the LEDs 22 is incident. The reflection portion 33 is a portion that is at a position facing the incidence portion 32 in the front direction, and that totally reflects the light reaching from the incidence portion 32 to convert the traveling direction of the light to the one direction or the other direction. The emitting portion 34 is a portion that is at a position facing the reflection portion 33 in a lateral direction, and that emits the light totally reflected by the reflection portion 33 to the outside.

The incidence portion 32 is located on a rear surface side of the lens 30, and rectangular sections corresponding to the plurality of LEDs 22 (see FIG. 22) aligned in each column on the substrate 21 are provided in the incidence portion 32 in a grid pattern. An incident surface having a cross-sectional shape that is an arc-shape about the optical axis of LED 22 and that expands outward is formed for each grid. Each section of the incidence portion 32 is designed as a free-form surface that easily concentrates the light incident from the LEDs 22 to a degree that is not parallel to the optical axes.

As illustrated in FIG. 18 and FIG. 22, the reflection portion 33 includes a total incident surface having a cross-sectional shape that obliquely intersects the optical axes of the LEDs 22 at a position facing the incidence portion 32 in the front direction, on the front face side of the lens 30. The total incident surface is designed to have a critical angle with which the light reaching from the incidence portion 32 is totally reflected to convert the optical path to the one direction (or the other direction) of the transverse directions intersecting the optical axes in each column of the LEDs 22. Here, the total incident surface may be designed to be a free-form surface that totally reflects the reached light such that the optical path is in the above-described one direction (or the other direction), and that also has a predetermined range of reflection angle in the front and back direction and the up-and-down direction.

The emitting portion 34 includes an emission surface having a cross-sectional shape inclined to the opposite direction from the tip between the total incident surface and the emission surface at a position facing the reflection portion 33 in the lateral direction. The emission surface may emit the light totally reflected by the reflection portion 33 to the outside at almost the same angle, or may further be designed to be a free-form surface that has a predetermined range of reflection angle in the front and back direction and the up-and-down direction. Particularly, the refractive index of the light at the emission surface may be appropriately set in consideration of, for example, a relative relationship with the refraction at the time when the light emitted from the emitting portion 34 passes through the outer lens 50, which will be described later. The same also applies to the above-described reflection portion 33.

A concave groove having a substantially V-shaped cross-section is formed between the light distribution controlling units 31 by an inclined outer surface of the reflection portion 33 (the outer side of the total incident surface) and an outer surface hanging down from the emission surface of the emitting portion 34. Such a concave groove between the light distribution controlling units 31 is a region capable of directly emitting the light centered on the optical axes from the LEDs 22 to the outside. That is, the region between the light distribution controlling units 31 is set such that light distribution control is performed in the front direction that is perpendicular to the vehicle side surface, and that is the optical axis direction of the LEDs 22.

### <<Additional Light Distribution Controlling Unit 35>>

As illustrated in FIG. 18, an additional light distribution controlling unit 35 is provided in each of an upper end and a lower end of each of the light distribution controlling units 31 in the lens 30. The additional light distribution controlling unit 35 refracts the light from the LEDs 22 overlapping the vicinities of the upper end and the lower end toward at least upward from the upper end and at least downward from the lower end at the upper end and the lower end in the up-and-down direction perpendicular to the transverse directions of the light distribution controlling unit 31, respectively.

The upper and lower additional light distribution controlling units 35 may include a free-form surface capable of refracting the light incident from the LEDs 22 at the upper and lower ends to upward from the upper end or downward from the lower end, respectively, the upper end and the lower end corresponding to the positions of the upper and lower additional light distribution controlling units 35, respectively. The specific shapes of the upper and lower additional light distribution controlling units 35 are design matters that may be appropriately defined. For example, the additional light distribution controlling units 35 illustrated in FIG. 18 have the shapes that are divided for each corresponding one of the light distribution controlling units 31. However, the additional light distribution controlling units 35 may form the same and uniform cross-sectional shape over the entire width in the transverse directions.

<Regarding Outer Lens 50>

As illustrated in FIG. 1, the outer lens 50 encloses the front end opening 14 of the light body 11, and covers the lens and the light source 20 thereinside. The outer lens 50 is integrally molded into a glove shape from a transparent material, such as glass or synthetic resin. As illustrated in FIG. 3, an inner circumference side of the outer lens 50 may be formed as a lens surface that refracts the light emitted from the lens 30 when necessary. For example, an outer surface of the outer lens 50 may be designed to diffuse the light on which the light distribution control has been performed in the aforementioned predetermined direction by the lens 30 with almost uniform intensity distribution.

As illustrated in FIG. 3, a flange 51 extending outward with the predetermine width is provided in an outer circumferential edge centered at the tip of the outer lens 50. The outer lens 50 is fixed to the light body 11 in a state where the flange 51 engages with the step 16 inside the front end opening 14 of the light body 11, and an annular gasket 52 of an elastic material is placed from above the flange 51 to hold the flange 51 in place with the flange 51 pressed against (the circumference of an attaching hole of) the side wall surface A of the vehicle.

The light body 11 is arranged in a state where the pair of openings 13 in the peripheral wall 12 faces the up-and-down direction. Additionally, when the inner circumference side of the outer lens 50 is a lens surface corresponding to the light distribution control of the lens 30, the outer lens 50 is arranged in a state where the lens surface faces a predetermined direction. Here, the support member 40 to which the light source 20 and the lens 30 are attached can be inserted into the light body 11 from the opening 13 from the direction intersecting the central axis, with the light body 11 and the outer lens 50 being fixed to the side wall surface A.

### <Regarding Operations of Vehicle Side Light 10>

Next, the operations of the vehicle side light 10 according to the first embodiment will be described.

As illustrated in FIG. 1, the vehicle side light 10 is constructed by supporting, in the light body 11, the support member 40 to which the light source 20 and the lens 30 are attached in advance. Here, the light source 20 is constructed by mounting the plurality of LEDs 22 on the surface of the single substrate 21. By using the LEDs 22 for the light source 20 instead of conventional electric bulbs, the service life becomes longer, the time and effort for replacement and the like are reduced, and the power consumption can also be reduced at a lower cost.

Additionally, the light source 20 is constituted by the single substrate 21, instead of two LED substrates as in a conventional vehicle side light. Here, all of the LEDs 22 mounted on the surface of the substrate 21 may be aligned and arranged in the same direction in which the optical axes are perpendicular to the substrate 21, and there is no need for a cumbersome operation such as bending the wiring of only a part of the LEDs 22 to make the illumination direction different. Accordingly, the number of components of the vehicle side light is reduced, not only the wiring to the single substrate 21 but also the mounting operation of the individual LEDs 22 becomes simple, the assembly can be easily performed, and the cost of the vehicle side light 10 can be reduced.

In the light source 20, the light from each of the individual LEDs 22 mounted on the single substrate 21 can also be distributed to the both sides of the vehicle side surface in addition to the front direction perpendicular to the vehicle side surface by the lens 30 arranged in the front direction of the light source 20. Accordingly, a dark portion that is not easily visible due to an insufficient illumination amount is not generated in any viewing directions required for the vehicle side light 10, and efficient light distribution control can be more easily performed only in necessary directions with a simple configuration. Note that the light distribution control by the lens 30 will be described later in detail.

As illustrated in FIG. 3, the light body 11 is fixed to (the circumference of the attaching hole of) the side wall surface A of the vehicle with the front end opening 14 being covered with the outer lens 50. Here, the light body 11 is arranged in a state where the pair of openings 13 in the peripheral wall 12 faces the up-and-down direction. Additionally, the outer lens 50 is arranged in a state where the lens surface on its inner circumference side faces a predetermined direction in accordance with the orientation of the lens 30, which will be described later.

Even when the light body 11 is fixed to the side wall surface A of the vehicle in this manner, the support member 40 to which the light source 20 and the lens 30 are attached in advance can be inserted into the light body 11 from the openings 13 of the light body 11 from the direction intersecting the central axis of the light body 11. At this time, the support member 40 is oriented and arranged in the light body 11 such that its leg 43 constitutes a substantially horizontal top surface, and the substrate 21 on the attaching surface part 42 becomes substantially parallel to the side wall surface A of the vehicle. With this arrangement, the orientations of the light source 20 and the lens 30 on the attaching surface part 42 match with their original transverse directions and the up-and-down direction.

In a conventional vehicle side light, it is common to insert two LED substrates into the light body along the central axis from the rear end opening of the light body. On the other hand, in the vehicle side light 10 of the present embodiment, the substrate 21 of the light source 20 is fixed in a state to be perpendicular to the central axis of the support member 40, and the substrate 21 is designed to secure the maximum light emission area in the limited space in the light body 11. However, the opening area of the rear end opening 17 of the light body 11 is reduced by the amount that the attaching pieces 18 on its both sides protrude inward. Here, suppose that the attaching pieces 18 are made to protrude outward from the outer circumference of the light body 11. Then, the size of the light body 11 itself will be bulky.

Accordingly, when inserting the support member 40 to which the light source 20 and the lens 30 are attached into the light body 11, the insertion is not performed from the rear end opening 17 of the light body 11, but by utilizing the openings 13 of the light body 11. In this manner, even when there is no space on a bottom surface side of the light body 11 for enabling the insertion of the support member 40 and the like from the direction along the central axis, the support member 40 together with the light source 20 and the lens 30 can be inserted into the light body 11 from the direction intersecting the central axis. Therefore, the support member 40 and the like can be easily attached into the light body 11.

Particularly, the support member 40 generally has the substantially U-shape in lateral view, and as illustrated in FIG. 1, the leg 43 to be passed through the openings 13 of the light body 11 has a narrow width. Therefore, the support member can be easily put into the light body 11 from the openings 13. Here, the attaching surface part 42 and the substrate 21 of the light source 20, whose diameters are larger than the width of the leg 43, have the maximum dimensions that can pass through the openings 13 as described above. Additionally, the fixing surface part 41 of the support member 40 is not put into the light body 11, and is screwed to each of the attaching pieces 18 from the outside of the rear end opening 17 of the light body 11.

In addition to a case of newly attaching the vehicle side light 10 of the present embodiment to a new vehicle, at the time of replacement of the LEDs 22 in an existing vehicle, the light body 11 already fixed to the side wall surface A is often left and utilized as is, and only the light source 20 is newly replaced by removing and inserting the support member 40. In the vehicle side light 10 as described above, it is also possible to utilize, without modification, the same light body as a conventional type vehicle side light that uses an electric bulb for the light source.

Additionally, the support member 40 can be simply formed by merely bending the one sheet metal 40A that is cut out into the predetermined shape as illustrated in FIG. 17. Since the support member 40 is integrally formed from a metal in this manner, the support member 40 also serves as a heat sink. Therefore, it becomes possible to efficiently perform heat dissipation of the LEDs 22 and the substrate 21 that are heated by light emission, and the temperature increase of the LEDs 22 and the substrate 21 can be suppressed. Particularly, since the rear surface of the substrate 21 is directly attached to the attaching surface part 42 by surface contact, heat can be efficiently transmitted from the substrate 21 to the attaching surface part 42. The heat transmitted from the substrate 21 to the attaching surface part 42 is also transmitted to the light body 11 via the leg 43 and the fixing surface part 41.

Incidentally, in a conventional vehicle side light, a sheet metal supporting two LED substrates at an angle is attached to the light body by being inserted into the light body from a gap of the rear end openings of the light body. However, at the time of such attachment, since LEDs are exposed on the substrate, there is a possibility that the LEDs contact an inner wall of the light body or other members, and the orientations of the LEDs are bent and the LEDs are damaged. On the other hand, in the vehicle side light 10 of the present embodiment, the lens 30 is attached onto the substrate 21 in the state where the lens 30 covers each of the LEDs 22 of the light source 20 from the front direction. Accordingly, the lens 30 serves to protect each of the LEDs 22, and can prevent the orientations of the LEDs 22 from being bent and prevent the LEDs 22 from being damaged when the support member 40 is inserted into the light body 11. Thus, the safety at the time of application is secured.

<<Light Distribution to Both sides by Lens 30>>

Next, the light distribution by the lens 30 will be described.

As illustrated in FIG. 22, in the lens 30, the left-side light distribution controlling units 31A and 31B and the right-side light distribution controlling units 31C and 31D are bilaterally symmetrically aligned by interposing the center line L of the transverse directions therebetween. Here, the light distribution controlling units 31 correspond to the respective columns of the LEDs 22 that are aligned in the four columns in the transverse directions on the substrate 21. Then, each light distribution controlling unit 31 defines the optical path of light for each column of the LEDs 22.

Among the light distribution controlling units 31, the left-side light distribution controlling units 31A and 31B emit the light incident from six LEDs 22 in the respective columns corresponding to these units to the one direction (the left direction on the paper of FIG. 22) of the transverse directions intersecting the optical axes of the LEDs 22. Additionally, the right-side light distribution controlling units 31C and 31D emit the light incident from six LEDs 22 in the respective columns corresponding to these units to the other direction (the right direction on the paper of FIG. 22) that is opposite to the one direction of the transverse directions intersecting the optical axes of the LEDs 22.

As illustrated by light beams in FIG. 22, the light emitted to the front direction (the Z-axis direction) from the LEDs 22 aligned on the substrate 21 is distributed by each light distribution controlling unit 31 toward the transverse directions intersecting the optical axes of the LEDs 22. Particularly, in the present embodiment, the emitted light from the lens 30 to the both sides is directed to directions (X-axis directions) that are substantially perpendicular to the optical axes of the LEDs 22 in a bilaterally symmetrical manner with the center line L of the transverse directions therebetween.

With the light distribution to the both sides of the vehicle side surface by the lens 30 as described above, it is possible to perform illumination whose luminous intensity peak is achieved also to the both sides that are substantially perpendicular to the optical axis of an ordinary LED 22 and in which the luminous intensity is low. Additionally, the light is not diffused in the circumferential direction about the optical axes, and the light can be focused at a high intensity on the both sides, by omitting unnecessary light distribution to directions in which illumination is not required. Particularly, in the present embodiment, since the same number of light distribution controlling units 31 are bilaterally symmetrically provided with the center line L of the transverse directions therebetween, the light having uniform intensity distribution can be distributed to the both sides.

### <<Light Distribution on One Side by Lens 30>>

Additionally, as illustrated in FIG. 22, in the lens 30, in both the left and right sides of the center line L of the transverse directions, the optical paths guiding the light incident from the LEDs 22 of the columns corresponding to the respective light distribution controlling units 31 in an optical axis direction become sequentially shorter in the order from the center side to the outer side (the one end side or the other end side) of the light distribution controlling units 31. Here, when referring to the length of the maximum optical path of each light distribution controlling unit 31 as the height, for example, on the right half side, the light distribution controlling unit 31C on the center side is high, and the light distribution controlling unit 31D on the outer side is low.

By making the heights of the light distribution controlling units 31 sequentially shorter in this manner, the light incident from the LEDs 22 of the column corresponding to each light distribution controlling unit 31 can be emitted to the same direction that intersects the optical axes of the LEDs 22 from a height position not interfering with the light distribution controlling unit 31 adjacent to the outer side (the one end side or the other end side). Accordingly, even when the light distribution controlling units 31 are aligned in the transverse directions, other light distribution controlling units 31 each located on a light illumination side does not disturb the emission of light. Thus, it becomes possible to efficiently emit the light corresponding to each column of the LEDs 22 to the same direction.

Particularly, in the present embodiment, the portions (the emitting portions 34) of tip sides of the light distribution controlling units 31C and 31D from which light is emitted to the same direction (the above-described other direction) are made sequentially lower in a staircase manner. Accordingly, the light having uniform intensity distribution can be distributed to the same direction from positions different in a staircase manner for the light distribution controlling units 31C and 31D. Although the horizontal width (corresponding to a stair tread of a step) between the light distribution controlling units 31C and 31D aligned in a staircase manner is a substantially equal distance in accordance with the intervals between the columns of the LEDs 22, it may not necessarily be the equal distance when the intervals between the columns of the LEDs 22 are different. Note that the same also applies to the light distribution controlling unit 31A and 31B on the left half side of the lens 30, and a duplicated description will be omitted.

### <<Details of Light Distribution by Lens 30>>

In FIG. 22, the light emitted from the LEDs 22 aligned in the four columns, each having six LEDs 22, on the substrate 21 of the light source 20 is incident into the inside of the light distribution controlling units 31 from the respective opposing incidence portions 32 of the light distribution controlling units 31 in the lens 30. The light incident from the incidence portions 32 travels in the front direction about the optical axes of the LEDs 22. With the incidence portions 32 as described above, it is possible to completely receive the light from the individual LEDs 22, and to efficiently direct the light to the reflection portions 33, which are located ahead of the optical axes of the LEDs 22, in a state where the light is concentrated to an appropriate illumination angle.

Subsequently, when the light traveling in the front direction inside the light distribution controlling units 31 from the incidence portions 32 reaches the reflection portions 33, the traveling direction of the light is converted to the above-described one direction or other direction by the total reflection at total reflection surfaces. With the total reflection at the reflection portions 33 as described above, the light distribution control can be efficiently performed even in directions that are substantially perpendicular to the optical axes of the LEDs 22, and it becomes possible to easily make the light travel in a desired direction.

Here, “substantially perpendicular” does not mean intersecting at right angles in a strict meaning, and may be visibly intersecting at almost right angles. In the present embodiment, as illustrated in FIG. 22, the one direction or the other direction in which total reflection is performed by the reflection portions 33 is slightly inclined to the front direction (an up direction on the paper of FIG. 22) from the direction perpendicular to the optical axes of the LEDs 22, and is slightly spread in the front and back direction. Additionally, although illustration is omitted, the one direction or the other direction may be slightly spread also in the up-and-down direction that is perpendicular to the optical axes.

When the light totally reflected by the reflection portions 33 reaches the emitting portions 34, the light is emitted to the outside at almost the same angle, or after being refracted to be further spread in the front and back directions and the up-and-down direction. Note that it also becomes possible to further expand the illumination angle range, to enhance the light diffusion effects, and to emit the light with a desired color by causing the light emitted from the emitting portions 34 to further pass through the outer lens 50.

With the series of refraction or reflection of light by the above-described incidence portions 32, reflection portions 33, and emitting portions 34, the light distribution control to the both sides by the lens 30 can be efficiently achieved. Generally, the reflective index of light is higher for total reflection than for a mirror surface. Therefore, by utilizing the total reflection of the lens 30, the light distribution control can be efficiently performed, it becomes possible to easily make the light travel in a desired direction, and the light extraction efficiency is also increased.

### <<Light Distribution in Front Direction by Lens 30>>

In FIG. 22, the concave groove having the substantially V-shaped cross-section is formed between the light distribution controlling units 31 by the inclined outer surface of the reflection portion 33 (the outer side of the total incident surface) and the outer surface hanging down from the emission surface of the emitting portion 34. However, the light distribution control is not particularly performed in such a portion, and the light centered on the optical axes from the LEDs 22 is freely emitted toward the front direction without controlled.

Accordingly, even in the front direction of the lens 30 to which the optical axes of the LEDs 22 are directed, it is possible to emit light that has a relatively low luminous intensity but that is sufficiently visible. Accordingly, it is also possible to secure the light distribution in, for example, the front direction (a front side) of the light body 11, that is, the front direction perpendicular to the vehicle side surface, which is required for the vehicle side light 10. Note that the emitted light in the front direction can also be supplemented with light that is leaked without being totally reflected by the reflection portions 33, and with light that is leaked from the emitting portions 34.

### <<Light Distribution in Additional Light Distribution Controlling Unit 35>>

As illustrated in FIG. 23, the light from the LEDs 22 overlapping the vicinities of the upper ends is refracted to be locally spread in the up direction by the additional light distribution controlling units 35 that are consecutively aligned on the upper ends of the light distribution controlling units 31. Similarly, the light from the LEDs 22 overlapping the vicinities of the lower ends is also refracted to be locally spread in a down direction by the additional light distribution controlling units 35 at the lower ends of the light distribution controlling units 31.

Accordingly, the illumination range in the up-and-down direction (Y direction) by the lens 30 can be expanded. Therefore, when the lens 30 is illuminated, the light emission area seen from the front direction does not appear small, and it entirely appears to glow also including the up-and-down direction, the appearance can be improved. Additionally, the light from the top and bottom LEDs 22 of the LEDs 22 that are aligned in the four columns, each having six LEDs 22, can also be sufficiently captured and utilized by the additional light distribution controlling units 35.

### Second Embodiment

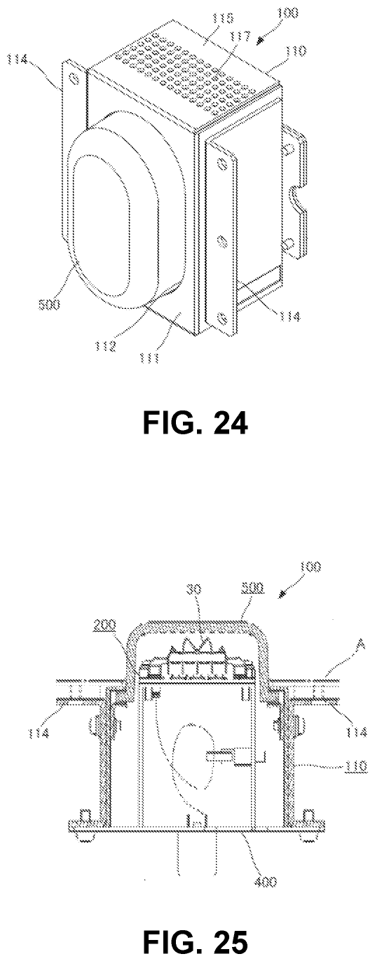

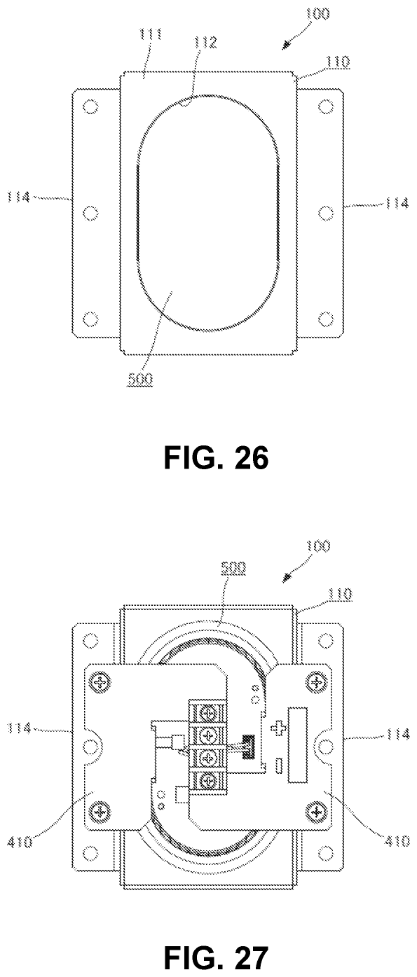

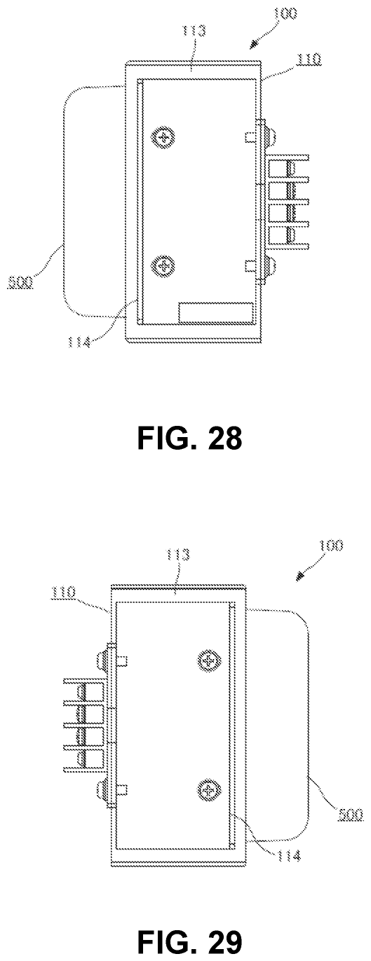

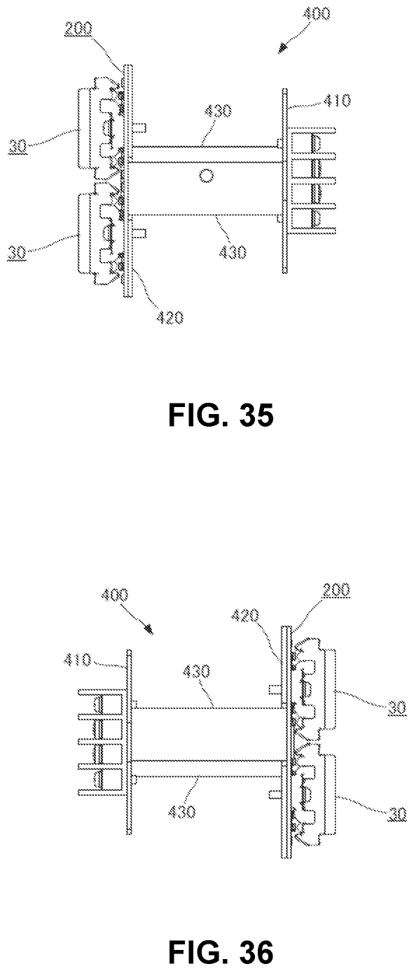

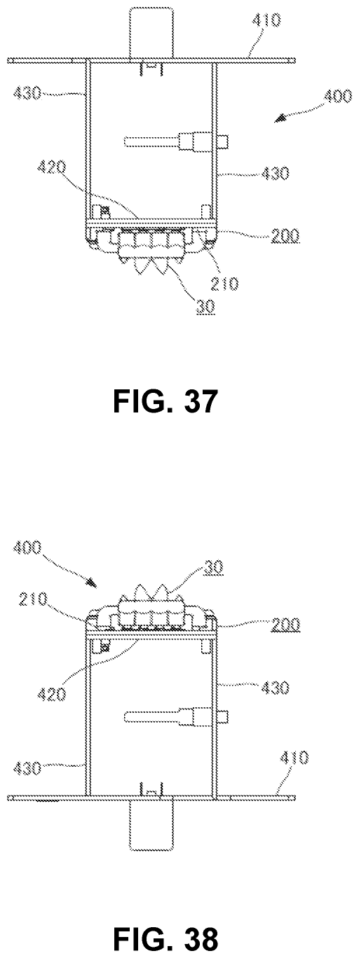

FIG. 24 to FIG. 39 illustrate a second embodiment.

A vehicle side light 100 according to the present second embodiment has basically the same configuration as the vehicle side light 10 according to the first embodiment. However, the specific configurations of a light body 110 to be fixed to a vehicle side surface, a light source 200 to be housed in the light body 110, the lens 30 that distributes light from the light source 200, and the support member 40 to which the light source 200 and the lens 30 are attached in advance and that is supported in the light body 110 are slightly different from those in the first embodiment, respectively. Note that portions similar to those in the first embodiment are denoted by the same numerals, and a duplicated description will be omitted.

### <Regarding Light Body 110>

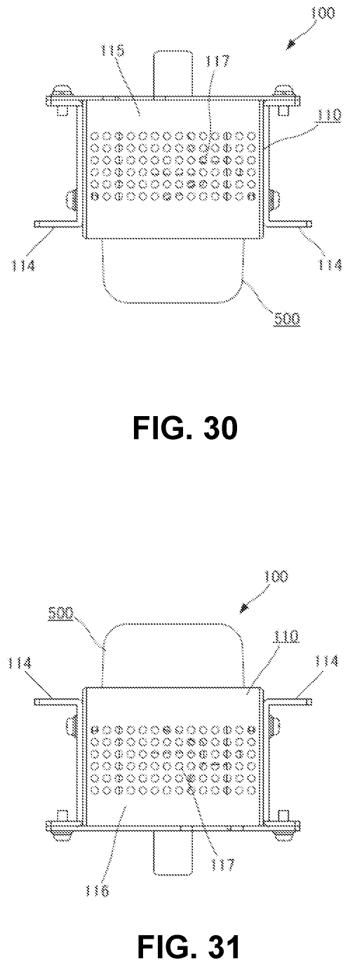

As illustrated in FIG. 24 to FIG. 31, the light body 110 has a generally rectangular parallelepiped shape, and an opening 112 into which an outer lens 500 is to be fitted is provided in a front face wall 111. A rear surface of the light body 110 is opened as is. An attaching bracket 114 to be fixed to the side wall surface A of the vehicle is provided to each of both side surface walls 113 and 113 of the light body 110. Additionally, as illustrated in FIG. 30 and FIG. 31, a large number of small holes 117 for heat dissipation are provided in each of a top wall surface 115 and a bottom surface wall 116 of the light body 110.

### <Regarding Light Source 200>

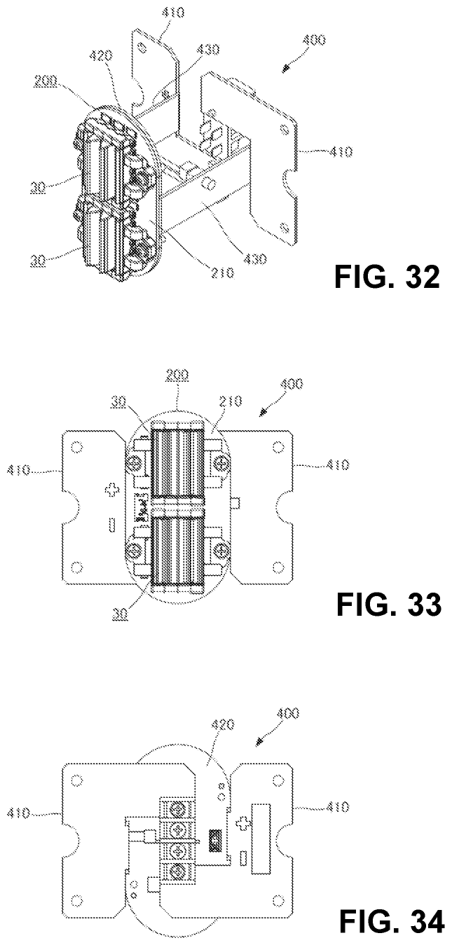

As illustrated in FIG. 32, the light source 200 is constructed by mounting the plurality of LEDs 22 (see FIG. 22) on a surface of a single substrate 210. Here, the substrate 210 is different from the substrate 21 in the first embodiment, and is formed into an oval shape that is approximately twice the size of the substrate 21. The surface of the substrate 210 is divided into upper and lower sides. Although illustration is omitted, on each of the upper side and the lower side, the LEDs 22 are aligned in four columns in the transverse directions, and six LEDs 22 are arranged at equal intervals in each column. That is, on each of the upper side and the lower side of the surface of the substrate 210, 24 LEDs 22 are mounted to be aligned in a matrix.

### <Regarding Lens 30>

As illustrated in FIG. 32, the lens 30 is the same as that in the first embodiment. However, in the present second embodiment, one lens 30 is arranged on each of the upper side and the lower side of the substrate 210 in accordance with the size of the substrate 210 of the light source 200, and a total of two lenses 30 are provided. The upper and lower lenses 30 are each attached onto the substrate 210 in a state of covering respective corresponding LEDs 22 and other electronic components on the surface of the substrate 210 from the front direction.

### <Regarding Support Member 400>

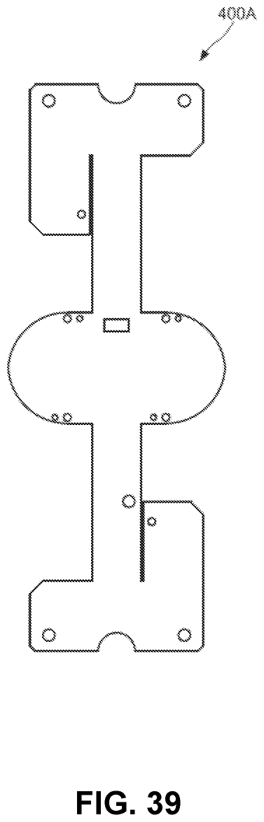

As illustrated in FIG. 32 to FIG. 38, the light source 200 and the two lenses 30 are attached to the support member 400 in advance, and then the support member 400 is supported in the light body 110. The support member 400 generally has a shape that exactly fits into the light body 110, and is integrally formed from a sheet metal of, for example, an aluminum alloy. The support member 400 as described above is formed by bending one sheet metal 400A that is cut out into a predetermined shape as illustrated in FIG. 39.

To be specific, by performing bending processing on the one sheet metal 400A, as illustrated in FIG. 32, the support member 400 includes a pair of fixing surface parts 410 to be fixed to rear end pieces of the attaching brackets 114 that extend from the both sides of a rear surface opening of the light body 110, an attaching surface part 420 to which the substrate 210 of the light source 200 is attached, and a pair of legs 430 that connect the respective fixing surface parts 410 and the attaching surface part 420 in a parallel state.

### <Regarding Operations of Vehicle Side Light 100>

Next, operations of the vehicle side light 100 according to the second embodiment will be described.

When the vehicle side light 100 of the present second embodiment is assembled, the support member 400 is inserted into the light body 110 from the rear surface opening of the light body 110 in a state where the substrate 210 of the light source 200 and the two lenses 30 are attached to the attaching surface part 420 in advance. Then, the pair of fixing surface parts 410 of the support member 400 are fixed to the rear end pieces of the attaching brackets 114 on the both sides of the light body 110. Accordingly, the support member 400 is supported in the light body 110 in a state where a central axis of the substrate 210, which is a central axis of the light source 200, is overlapped with a central axis of the light body 110.

With the vehicle side light 100 as described above, by aligning the two lenses 30 on the upper and lower sides, and providing the LEDs 22 corresponding to each of the lenses 30, the light distribution by the lens 30 in the aforementioned first embodiment can be performed with the large light emission area of the outer lens 500, and the display by the vehicle side light 100 can be illuminated in an even more visible manner. Note that, in the vehicle side light 10 in the first embodiment, the same light body as a conventional type vehicle side light that uses an electric bulb for the light source can be utilized without modification. However, in the vehicle side light 100 in the second embodiment, the new light body 110 is to be prepared.

### [Modification 1 of Lens 30]

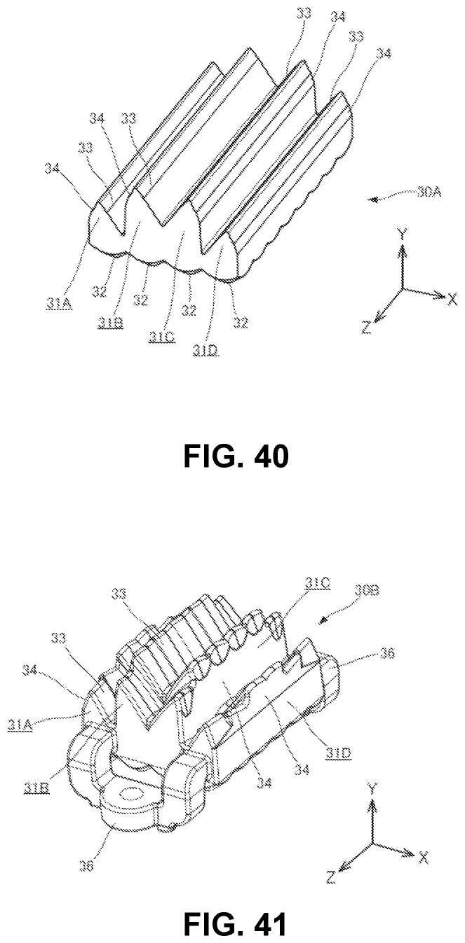

FIG. 40 illustrates Modification 1 of the lens 30.

A lens 30A in the present Modification 1 has basically the same configuration as the lens 30 in the first embodiment. However, the lens 30A in the present Modification 1 is different in that no additional light distribution controlling unit 35 is provided in the upper and lower ends of each of the light distribution controlling units 31. That is, the lens 30A in the present Modification 1 has a generally vertical rectangular shape that is long in the up-and-down direction in planar view, and is formed to have the same transverse cross-sectional shape (see FIG. 22) over the entire length in its up-and-down direction.

Accordingly, although the light distribution by the aforementioned additional light distribution controlling units cannot be performed, the shape of the lens 30A can be simplified. Additionally, whether or not to provide the attaching portions 36 is a design matter that can be appropriately selected. Note that portions similar to those of the lens 30 in the first embodiment are denoted by the same numerals, and a duplicated description will be omitted.

### [Modification 2 of Lens 30]

FIG. 41 illustrates Modification 2 of the lens 30.

A lens 30B in the present Modification 2 also has basically the same configuration as the lens 30 in the first embodiment. However, the shapes and the like of tip sides from the upper end to the lower end of each of the light distribution controlling units 31 are different. Note that portions similar to those of the lens 30 in the first embodiment are denoted by the same numerals, and a duplicated description will be omitted.

As illustrated in FIG. 41, in the lens 30B, the tip side of each light distribution controlling unit 31 extending in the up-and-down direction that is perpendicular to the transverse directions on the side opposite to the side facing the LEDs 22 does not have shapes along a straight line parallel to the substrate 21, and is provided into shapes that refract the light from the LEDs 22 also in the up-and-down direction. It is conceivable to make these shapes into, for example, arc-like curved shapes, staircase-like shapes that are highest in the center and sequentially becomes lower toward the upper and lower ends, and the like. However, in the present Modification 2, the tip side of each light distribution controlling unit 31 has a different shape at predetermined intervals.

That is, among the light distribution controlling units 31, in the light distribution controlling units 31B and 31C close to the center line of the transverse directions, the tip side extending in the up-and-down direction protrudes in the front direction at portions corresponding to four sections on a center side in each column of the LEDs 22, and is lower at portions corresponding to the upper end section and the lower end section, which are at both ends of the four sections. Additionally, among the light distribution controlling units 31, in the light distribution controlling units 31A and 31D on the both ends in the transverse directions, the tip side extending in the up-and-down direction protrudes in the front direction in portions corresponding to two sections on the center side of each column of the LEDs 22, and is lower in portions corresponding to the upper end section and the lower end section, which are at both ends of the two sections.

With the lens 30B as described above, the light emitted in the one direction (the other direction) of the transverse directions from each of the light distribution controlling units 31 is reflected to be spread also in the up-and-down direction with the shapes of the tip sides. Accordingly, the illumination range in the up-and-down direction by the lens 30B can be expanded for each of the light distribution controlling units 31. Particularly, with the light distribution controlling units 31 of the lens 30B, in addition to the light distribution control on the both sides and the light distribution control on one side in each column of the LEDs 22, it is possible to individually perform fine light distribution control even in each row of the LEDs 22.

### [Configuration, Operations and Effects of Present Invention]

Although the various embodiments of the present invention has been described above, the present invention is not limited to the aforementioned various embodiments. The present invention to be derived from the aforementioned various embodiments will be described below.

[1] First, the present invention is

a vehicle side light 10, 100 that is provided on a vehicle side surface, and that is constructed by supporting, in a light body 11, 110, a light source 20, 200 and a lens 30, 30A, 30B for distributing light from the light source 20, 200,

wherein the light source 20, 200 is constructed by mounting a plurality of light emitting elements 22 on a surface of a single substrate 21, 210, and

the lens 30, 30A, 30B is arranged in a front direction of the light source 20, 200, and is capable of distributing light of any of the plurality of light emitting elements 22 to both sides of the vehicle side surface in addition to the front direction perpendicular to the vehicle side surface.

In this manner, the light source 20, 200 is constructed by the single substrate 21, 210, instead of two substrates as in a conventional vehicle side light. Accordingly, the number of components of the vehicle side light 10, 100 is reduced, the wiring and assembly to the single substrate 21, 210 also becomes easy, and the cost can be reduced.

Then, the light from each of the individual light emitting elements 22 mounted on the single substrate 21, 210 can be also distributed to the both sides of the vehicle side surface in addition to the front direction perpendicular to the vehicle side surface by the lens 30, 30A, 30B arranged in the front direction of the light source 20, 200. Accordingly, a dark portion that is not easily visible due to an insufficient illumination amount is not generated in any viewing directions required for the vehicle side light 10, 100, and efficient light distribution control can be more easily performed only in necessary directions with a simple configuration.

Generally, a station employee and a conductor visually confirm the illumination of a vehicle side light from the front or rear side of a vehicle. Here, when the luminous intensity in the transverse directions of the vehicle side light is weak, it is difficult to distinguish between the vehicle side light and the reflection of other light and the like on a vehicle side surface, and it is difficult to correctly determine the illumination of the vehicle side light. On the other hand, with the present vehicle side light 10, 100, the illumination can be easily and correctly determined.

[2] Additionally, the present invention

includes the support member 40 to which the light source 20 and the lens 30, 30A, 30B are attached in advance, and that is supported in the light body 11,

the support member 40 is supported in the light body 11 in a state where the central axis of the light source 20 overlaps with the central axis of the light body 11, and the light source and the lens 30, 30A, 30B can also be inserted into the light body 11 from a direction intersecting the central axis of the light body 11.

Accordingly, even when there is no opening on the bottom surface side of the light body 11 for enabling the insertion of the support member 40 and the like from the direction along the central axis, the support member 40 together with the light source 20 and the lens 30, 30A, 30B can be inserted into the light body 11 from a direction intersecting the central axis of the light body 11. Accordingly, the support member 40 and the like can be easily attached into the light body 11. A space, such as an opening or a gap, from which the support member 40 and the like can be put into the light body 11 may be provided in a side direction (peripheral wall) of the light body 11.

[3] Additionally, in the present invention,

the support member 40, 400 is integrally formed from a metal, and includes the attaching surface part 42, 420 to which the rear surface of the substrate 21, 210 of the light source 200 is attached by surface contact.

By integrally forming the support member 40, 400 from the metal in this manner, it becomes possible to efficiently perform heat dissipation of the light source 20, 200, and to suppress the temperature increase of the light source 20, 200. Particularly, since the rear surface of the substrate 21, 210 contacts the attaching surface part 42, 420 by surface contact, heat can be efficiently transmitted from the substrate 21, 210 to the attaching surface part 42, 420.

[4] Additionally, in the present invention,

the support member 40, 400 is formed by bending the one sheet metal 40A, 400A that is cut out into the predetermined shape.

Accordingly, the support member 40, 400 can be constructed very simply.

[5] Additionally, in the present invention,

the lens 30, 30A, 30B is attached onto the substrate 21, 210 in a state of covering the plurality of light emitting elements 22 of the light source 20, 200 from the front direction.

Accordingly, the lens 30, 30A, 30B serves to protect each of the light emitting elements 22, and can prevent the orientations of the light emitting elements 22 from being bent and prevent the light emitting elements 22 from being damaged when the support member 40 is inserted into the light body 11, 110. Thus, the safety at the time of application is secured. Note that the lens 30, 30A, 30B may be designed to cover not only the light emitting elements 22, but also other related electronic components disposed on the surface of the substrate 21, 210 from the front direction.

[6] Additionally, in the present invention,

the light source 20, 200 is constructed by aligning the plurality of light emitting elements 22 on the surface of the substrate 21, 210 in a plurality of columns in the transverse directions, and mounting the plurality of light emitting elements 22 in a state where the optical axis of each of the light emitting elements 22 is aligned parallel in the same direction perpendicular to the substrate 21, 210,

the lens 30, 30A, 30B includes the plurality of light distribution controlling units 31 that are consecutively aligned in the transverse directions so as to correspond to the respective columns of the plurality of light emitting elements 22, and that define the optical path of the light from the light emitting elements 22 in each of the columns, the same number of light distribution controlling units 31 are bilaterally symmetrically provided by interposing the center line of the transverse directions of the lens 30, 30A, 30B therebetween,

the light distribution controlling units 31 on one of a left side and a right side of the center line among the light distribution controlling units 31 emit the light incident from the light emitting elements 22 of the columns corresponding to the light distribution controlling units 31 to one direction of both sides of the vehicle side surface, and

the light distribution controlling units 31 on the other of the left side and the right side of the center line among the light distribution controlling units 31 emit the light incident from the light emitting elements 22 of the columns corresponding to the light distribution controlling units 31 to the other direction of the both sides of the vehicle side surface.

Accordingly, among the light distribution controlling units 31 of the lens 30, 30A, 30B, the light distribution controlling units 31 on one of the left side and the right side emit the light incident from the light emitting elements 22 of the columns corresponding to the light distribution controlling units 31 to one direction of the both sides of the vehicle side surface. Additionally, the light distribution controlling units 31 on the other of the left side and the right side emit the light incident from the light emitting elements 22 of the columns corresponding to the light distribution controlling units 31 to the other direction of the both sides of the vehicle side surface.

Accordingly, it is possible to perform illumination whose luminous intensity peak is achieved also to the both sides that are substantially perpendicular to the optical axis of an ordinary light emitting element 22 and in which the luminous intensity is low. Additionally, the light is not diffused in the circumferential direction about the optical axes, and the light can be focused at a high intensity in the one direction and the other direction of the transverse directions, by omitting unnecessary light distribution to directions in which illumination is not required.

[7] Additionally, in the present invention,

in the light distribution controlling units 31 on one of the left side and the right side of the center line among the light distribution controlling units 31, the optical paths guiding the light incident from the light emitting elements 22 of the columns corresponding to the respective light distribution controlling units 31 in an optical axis direction become sequentially shorter in the order from the center side close to the center line to one end side, each of the light distribution controlling units 31 emits the light incident from the light emitting elements 22 of the column corresponding to the light distribution controlling unit 31 to the one direction from a height position not interfering with the light distribution controlling unit 31 adjacent to the one end side,

also in the light distribution controlling units 31 on the other of the left side and the right side of the center line among the light distribution controlling units 31, the optical paths guiding the light incident from the light emitting elements 22 of the columns corresponding to the respective light distribution controlling units 31 in the optical axis direction become sequentially shorter in the order from the center side close to the center line to the other end side, and each of the light distribution controlling units 31 emits the light incident from the light emitting elements 22 of the column corresponding to the light distribution controlling unit 31 to the other direction from a height position not interfering with the light distribution controlling unit 31 adjacent to the other end side.

Accordingly, each of the light distribution controlling units 31 of the lens 30, 30A, 30B can emit the light incident from the light emitting elements 22 of the column corresponding to the light distribution controlling unit 31 in the same direction (the one direction or the other direction) that intersects the optical axes of the light emitting elements 22 from a position not interfering with the light distribution controlling unit 31 adjacent to the one end side or the other end side.

Accordingly, even when the light distribution controlling units 31 are aligned in the transverse directions, the adjacent light distribution controlling unit 31 on the one end side or the other end side does not disturb the emission of light. Thus, it becomes possible to efficiently emit the light corresponding to each column of the light emitting elements 22 to the same direction (the one direction or the other direction). Therefore, it becomes possible to perform illumination whose luminous intensity peak is achieved also in directions that are substantially perpendicular to an optical axis of an ordinary light emitting element 22 and in which the luminous intensity is low. Additionally, the light is not diffused in the circumferential direction about the optical axes, and the light can be focused at a high intensity in the same direction.

Although the embodiments of the present invention has been described above with the drawings, the specific configuration is not limited to the embodiments as described above, and any modifications and additions that do not depart from the scope of the present invention are also included in the present invention. For example, in the above-described embodiments, the description has been given by taking the door closing vehicle side light as an example of a vehicle side light. However, the kind of vehicle side light is not limited to the door closing vehicle side light, and can be widely applied to other kinds of vehicle side lights.

Additionally, the light emitting elements constituting the light source 20, 200 are not limited to the LEDs, and LDs (semiconductor lasers) or the like may be included as other semiconductor light emitting elements. Further, although the LEDs 22 are aligned in a matrix on the substrate 21, 210, the connection of the wiring circuit to each of the LEDs 22 may be set such that the balance between the illumination states on the left and right sides of the vehicle side light 10 is not lost even when a failure such as disconnection occurs in any of the LEDs 22.

### INDUSTRIAL APPLICABILITY

The vehicle side light according to the present invention is not limited to a door closing vehicle side light of a railroad vehicle, but can also be widely applied to various kinds of vehicle side lights.

### REFERENCE SIGNS LIST

10, 100 . . . vehicle side light
11, 110 . . . light body
12 . . . peripheral wall
13 . . . opening
14 . . . front end opening
16 . . . step
17 . . . rear end opening
10 20, 200 . . . light source
21, 210 . . . substrate
22 . . . LED
30A, 30B . . . lens
31A, 31B, 31C, 31D . . . light distribution controlling unit
32 . . . incidence portion
33 . . . reflection portion
34 . . . emitting portion
35 . . . light distribution controlling unit
36 . . . attaching portion
40, 400 . . . support member
41, 410 . . . fixing surface part
42, 420 . . . attaching surface part
43, 430 . . . leg

1. A vehicle side light that is provided on a vehicle side surface, and that is constructed by supporting, in a light body, a light source and a lens for distributing light from the light source,
wherein the light source is constructed by mounting a plurality of light emitting elements on a surface of a single substrate, and
the lens is arranged in a front direction of the light source, and is capable of distributing light of any of the plurality of light emitting elements to both sides of the vehicle side surface in addition to the front direction perpendicular to the vehicle side surface.

2. The vehicle side light according to claim 1, comprising:
a support member to which the light source and the lens are attached in advance, and that is supported in the light body,
wherein the support member is supported in the light body in a state where a central axis of the light source overlaps with a central axis of the light body, and the light source and the lens can also be inserted into the light body from a direction intersecting the central axis of the light body.

3. The vehicle side light according to claim 1, wherein the support member is integrally formed from a metal, and includes an attaching surface part to which a rear surface of the substrate of the light source is attached by surface contact.

4. The vehicle side light according to claim 3, wherein the support member is formed by bending one sheet metal that is cut out into a predetermined shape.

5. The vehicle side light according to claim 1, wherein the lens is attached onto the substrate in a state of covering the plurality of light emitting elements of the light source from the front direction.

6. The vehicle side light according to claim 1, wherein the light source is constructed by aligning the plurality of light emitting elements on the surface of the substrate in a plurality of columns in transverse directions, and mounting the plurality of light emitting elements in a state where an optical axis of each of the light emitting elements is aligned parallel in the same direction perpendicular to the substrate,
the lens includes a plurality of light distribution controlling units that are consecutively aligned in the transverse directions so as to correspond to the respective columns of the plurality of light emitting elements, and that define an optical path of light from the light emitting elements in each of the columns, the same number of the light distribution controlling units are bilaterally symmetrically provided by interposing a center line of the transverse directions of the lens therebetween, the light distribution controlling units on one of a left side and a right side of the center line among the light distribution controlling units emit the light incident from the light emitting elements of the columns corresponding to the light distribution controlling units to one direction of both sides of the vehicle side surface, and
the light distribution controlling units on the other of the left side and the right side of the center line among the light distribution controlling units emit the light incident from the light emitting elements of the columns corresponding to the light distribution controlling units to the other direction of the both sides of the vehicle side surface.

7. The vehicle side light according to claim 6, wherein, in the light distribution controlling units on the one of the left side and the right side of the center line among the light distribution controlling units, optical paths guiding the light incident from the light emitting elements of the columns corresponding to the respective light distribution controlling units in an optical axis direction become sequentially shorter in an order from a center side close to the center line to one end side, each of the light distribution controlling units emits the light incident from the light emitting elements of the column corresponding to the light distribution controlling unit to the one direction from a height position not interfering with the light distribution controlling unit adjacent to the one end side,
also in the light distribution controlling units on the other of the left side and the right side of the center line among the light distribution controlling units, optical paths guiding the light incident from the light emitting elements of the columns corresponding to the respective light distribution controlling units in the optical axis direction become sequentially shorter in an order from the center side close to the center line to the other end side, and each of the light distribution controlling units emits the light incident from the light emitting elements of the column corresponding to the light distribution controlling unit to the other direction from a height position not interfering with the light distribution controlling unit adjacent to the other end side.
